(19) United States
(12) Patent Application Publication
(10) Pub. No.: US 2005/0030251 A1
(43) Pub. Date: Feb. 10, 2005

(54) Antenna coil and transmission antenna

(76) Inventors: Shinji Okamura, Tokyo (JP); Hozumi Ueda, Tokyo (JP)

Correspondence Address: FINNEGAN, HENDERSON, FARABOW, GARRETT & DUNNER;LLP, 1300 I STREET, NW, WASHINGTON, DC, 20005, US

(21) Appl. No.: 10/493,406

(22) PCT Filed: Sep. 30, 2002
(86) PCT No.: PCT/JP02/10191

(30) Foreign Application Priority Data
Oct. 22, 2001 (JP) 01/09251

(51) Int. Cl. H01Q 7/08; H01Q 1/36

(52) U.S. Cl. 343/895; 343/788

(57) ABSTRACT

In a transmission antenna provided with an antenna coil ouffitted with a core whereon a coil is mounted by winding, and with a capacitor connected to the aforementioned coil forming a serial resonance circuit between the aforementioned antenna coil inductance, the aforementioned antenna coil is outfitted with small core screw with a core smaller than the aforementioned core, and with a joining material that magnetically joins the aforementioned screw to the aforementioned core and with a screw hole that serves as a non-magnetic distance adjuster whereby the distance between the aforementioned core and the aforementioned screw is adjustable, and the resonance frequency is set by adjusting the thread volume of the aforementioned screw.

### TECHNICAL FIELD

The present invention relates to a transmission antenna used in, for example, RFID (Radio Frequency Identification) and such at a LF (Low Frequency) band.

### PRIOR ART

Conventionally, a transmission antenna is used for the aforementioned LF band RFID in door key locking and unlocking. In this case, a conventional transmission antenna is a resonance circuit structured so that an antenna coil is mounted by winding onto a ferrite core, and this antenna coil is connected to a capacitor. The capacitor capacity and the number of cycles in the analog coil are set so as to yield the desired resonance frequency.

With capacitors, though, it is hard to produce products accurately with the same static electricity capacity. Discrepancies arise is the static electricity capacities of manufactured capacitors. Discrepancies also arise in the inductances of analog coils. Thus there are times these discrepancies cause gaps in the resonance frequency, and the electromotive force that an antenna generates decreases. Consequently, there is concern about the communication distance shortening.

### INVENTION DISCLOSURE

The present invention was created to correct the aforementioned conditions and its objective is to obtain a transmission antenna whose resonance is easily regulated. Another objective is to provide an antenna coil used in this sort of transmission antenna. The present invention also lies in obtaining a transmission antenna with adjustable resonance frequency without affecting the directivity of the antenna. Another objective is provide the antenna coil used in this sort of transmission antenna.

Firstly, the present invention provides an antenna coil outfitted with a core whereon a coil is mounted by winding and wherein a small hole is perforated, and a small core provided in a mobile fashion in the aforementioned small hole.

Secondly, the present invention provides a core whereon a coil is mounted by winding, a small core that is smaller than this core, and a joining material that magnetically joins the aforementioned core whereon a coil is mounted by winding to the aforementioned small core and having a non-magnetic distance adjuster to adjust the distance between the aforementioned core and the aforementioned small core.

Thirdly, the present invention provides an antenna coil whereby in a transmission antenna outfitted with an antenna coil having a core whereon a coil is mounted by winding and a capacitor connected to the aforementioned coil and forming a serial resonance circuit between the inductance of the aforementioned antenna coil, the aforementioned antenna coil is provided with a small core smaller than the aforementioned core and a joining material that magnetically joins the aforementioned small core to the aforementioned core and having a non-magnetic material component whereby the distance between the aforementioned core and the aforementioned small core can be adjusted.

Fourthly, the present invention provides a transmission antenna and an antenna coil whereby the aforementioned distance adjuster is such that the aforementioned small core is mobile in the direction of the magnetic flux generated by the aforementioned core whereon the aforementioned coil is mounted by winding.

Fifthly, the present invention provides an antenna coil outfitted with a first bobbin whereon a coil is mounted by winding, a second bobbin whereon a coil is mounted by winding and provided in the center part of the aforementioned first bobbin, and a ferrite core provided in a mobile fashion in the center of the aforementioned second bobbin.

Sixthly, the present invention provides an antenna coil having a first bobbin whereon a coil is mounted by winding, a second bobbin whereon a coil is mounted by winding and that is provided in the center of the aforementioned bobbin, and a ferrite core provided in a mobile fashion in the center of the aforementioned second bobbin, and a capacitor whereby the coil wound onto the aforementioned first bobbin and the coil wound onto the aforementioned second bobbin are connected serially, and a capacitor that is serially connected thereto and that forms a serial resonance circuit between the inductance of the aforementioned antenna coil.

Seventhly, the present invention provides a transmission antenna outfitted with a first coil, a second coil wound onto a bobbin having a ferrite core provided in a mobile fashion in the center, and a capacitor, and whereby the aforementioned first coil, the aforementioned second coil, and the aforementioned capacitor are serially connected to form a serial resonance circuit.

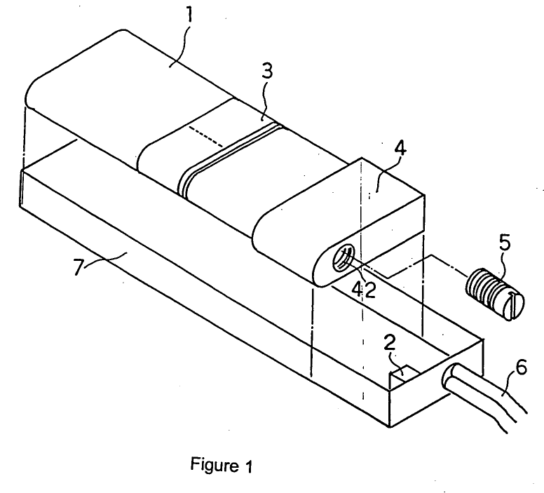

FIG. 1 is a perspective diagram depicting the transmission antenna of the present invention.

FIG. 2 is a top-down view diagram depicting the first antenna coil that is the main component of the transmission antenna of the present invention.

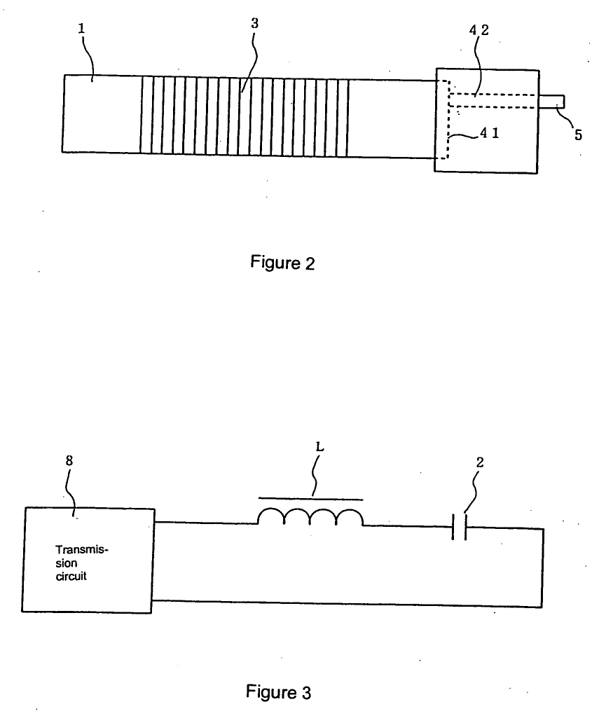

FIG. 3 is a circuit diagram of the first embodiment of the transmission antenna of the present invention.

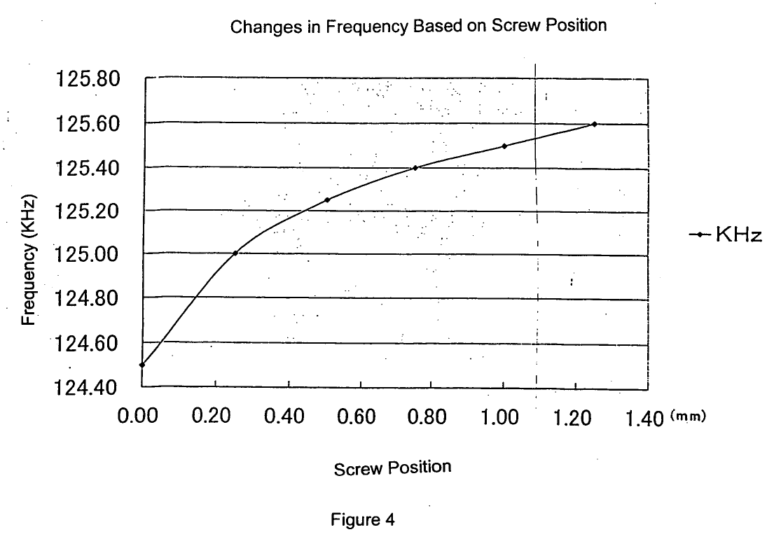

FIG. 4 is a diagram depicting the relationship between screw position and resonance circuit frequency in the transmission antenna of the present invention.

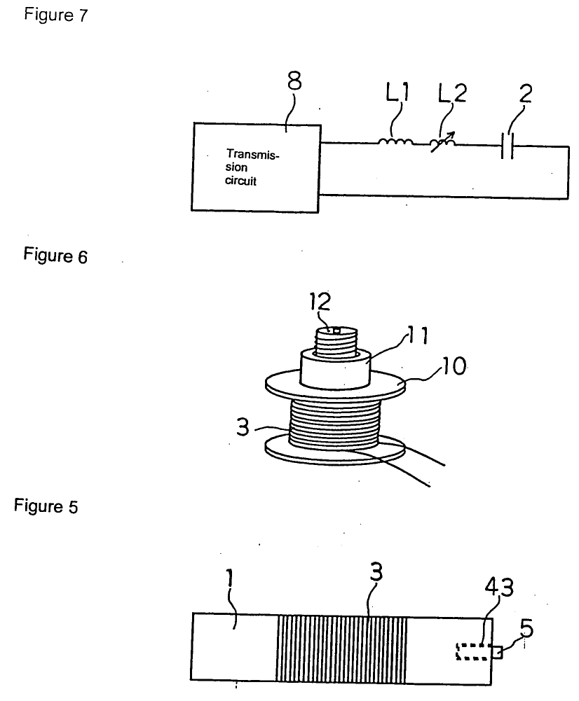

FIG. 5 is a top-down view diagram depicting a modified example of the first antenna coil that is the main component of the transmission antenna of the present invention.

FIG. 6 is a perspective diagram depicting the second antenna coil that is the main component of the second embodiment of the transmission antenna of the present invention.

FIG. 7 is a circuit diagram of the second embodiment of the transmission antenna of the present invention.

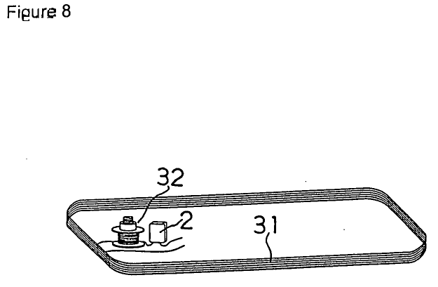

FIG. 8 is a perspective diagram depicting the structure of a resonance circuit wherein the second embodiment of the transmission antenna of the present invention is realized using the antenna coil depicted in FIG. 6.

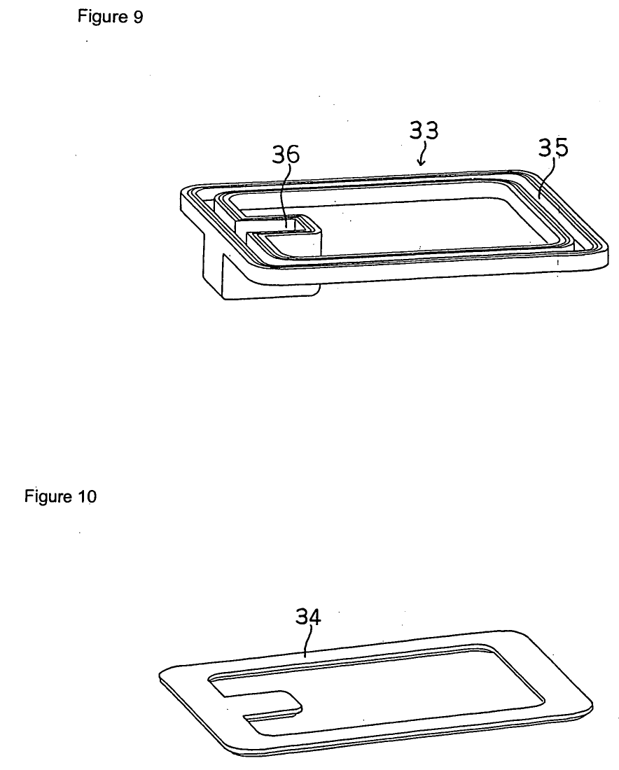

FIG. 9 is a perspective view depicting a case to house the resonance circuit of FIG. 8.

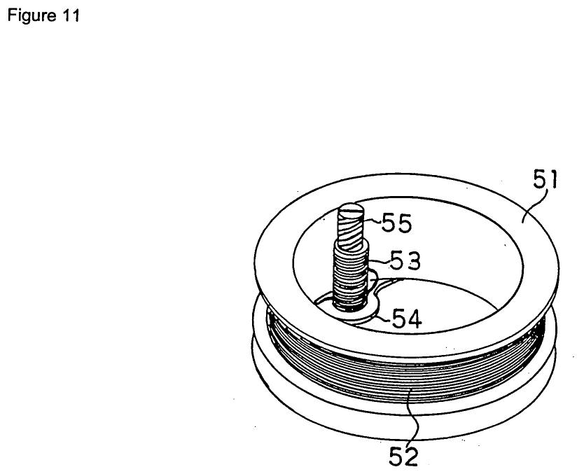

FIG. 10 is a top-down view diagram depicting the lid of the case of FIG. 9.

FIG. 11 is a perspective diagram depicting the structure of a resonance circuit when the second embodiment of the transmission antenna of the present invention is realized using a bobbin as an antenna coil.

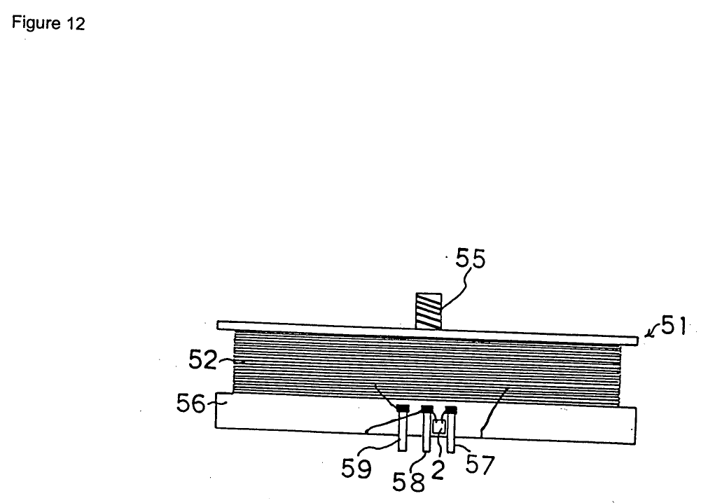

FIG. 12 is a full-frontal diagram depicting the structure of a resonance circuit when the second embodiment of the transmission antenna of the present invention is realized using a bobbin as an antenna coil.

### OPTIMUM FORM TO EMBODY THE INVENTION

As depicted by the perspective diagram of FIG. 1 and the main component top-down view diagram of FIG. 2, respectively, the transmission antenna of the present embodiment is outfitted with a ferrite core (1) and a capacitor (2). An antenna coil (3) is mounted by being wound onto the ferrite core (1). The core (1) forms a flat bar and mated to one of its lengthwise ends is a small flat piece of plastic (a non-magnetic material) that serves as a distance adjuster (4). Namely, formed in one end of the distance adjuster (4) is an indented part (41) whose size corresponds to an end of core (1). One end of core (1) is inserted into, and thus mated to, this indented part.

A screw hole (42) facing the core (1) end mated to the aforementioned indented part (41) is formed in the end face of that side of the distance adjuster (4) wherein the indented part (41) is not formed. A screw (5) with a small core made of, for example, ferrite is threaded into this screw hole (42). The capacitor (2) is connected to the antenna coil (3) of antenna coil (L) outfitted with a core (1) on which the antenna coil (3) is mounted by winding. As FIG. 3 depicts, the inductance of antenna coil (L) and capacitor (2) form a serial resonance circuit.

The inductance value of the antenna coil (L) can be changed by adjusting the thread volume of the screw (5). FIG. 4 depicts the relationship between the screw (5) position (distance from the core) and the frequency of the resonance circuit. The resonance frequency is lowest when the screw (5) is in direct contact with the core (1). The resonance frequency can be gradually increased by diminishing the screw thread volume.

As for FIG. 4 data, the capacity of the capacitor (2) used is 3300 pF. The size of the core (1) is 50 (mm)×12 (mm)×3(mm). The screw (5) size is: Diameter 3.8 (mm) and length 3.5 (mm); the antenna coil (3) used is wound 102 times.

The transmission antenna is such that the antenna coil (L) and the capacitor (2) are connected and are further connected to an external derivation lead wire (6). This is housed in a case (7) with a lid not shown in the figures. As FIG. 3 depicts, this is connected to a transmission circuit (8) and electromagnetic waves can be transmitted.

Prior to housing in the aforementioned case (7), adjustment of the thread volume of the screw (5), setting the desired resonance frequency, and lowering the resonance circuit inductance increase the current value in the resonance circuit. By adjusting in this way, the magnetic flux emitted from the transmission antenna increases and, with the same power consumption, communication distance can be increased.

Furthermore, the perforation direction of the screw hole (42) serving as the distance adjuster is the direction of the magnetic flux generated by the core (1). Since the small core screw is mobile in the direction of the magnetic flux generated by the core (1) whereon the antenna coil (3) is mounted by winding, the direction of the magnetic flux is stable. Such generation can occur without changing the antenna directionality, even when changing the resonance frequency by adjusting the thread volume of the screw (5).

In the aforementioned embodiment, the material of the aforementioned screw (5) is ferrite. Thus, there is a relation between the thread volume of the screw (2) as depicted in FIG. 4 and the resonance frequency of the resonance circuit. However, when the screw (2) is made of copper or aluminum with a relative magnetic permeability below 1 (a negative relative magnetic permeability), the resonance frequency can be increased as the thread volume of the screw (2) is increased.

Furthermore, a structure is depicted whereby a screw (5) is thread into the screw hole (42) that serves as a distance adjuster. Also appropriate, though, is a structure whereby a hole without a screw is provided instead of a screw hole (42) and wherein is inserted a slideable tubular pin to an appropriate position and fixed by an adhesive, etc.

FIG. 5 depicts a structural example of an antenna coil not provided with a distance adjuster (4). This antenna coil is such that a screw hole (43), which is a small hole, is formed from an end of the core (1). Threaded into this screw hole (43) is a screw (5) made of ferrite. The screw (5) is slideable and can reach an inductance value corresponding to the thread volume. The relation between the thread volume and the resonance circuit frequency is the same in an antenna coil structure in this way and that depicted in FIG. 4. Furthermore, depicted is a structure whereby the screw hole (43) is formed in the center of the end of the core (1). However, this location is not limited to the center and may be any position, provided it is in the end of the core (1).

In the preceding invention, the transmission antenna has the circuit structure that depicted in FIG. 3. As FIG. 7 depicts, a first coil whereby the inductance value is set and a second coil whereby the inductance value is variable can be used. The first coil (L1), the second coil (L2), and the capacitor (2) are connected serially to form a serial resonance circuit. This is connected to a transmission circuit such that electromagnetic waves can be emitted.

The second coil (L2) that FIG. 7 depicts corresponds to the small L-value adjustment coil comprised of the second coil (32) FIG. 6 depicts and to the coil (53), bobbin (54), and screw (55) that FIG. 11 and FIG. 12 depict. The first coil (L1) in FIG. 7 corresponds to the first coil (31) FIG. 8 depicts and the coil (52) FIG. 11 depicts. In FIG. 7, the structure is such that the small L-value adjustment coil (L2) is connected to the antenna coil (L1) which becomes the main (coil). The examples in FIG. 2 and FIG. 5, by contrast, themselves constitute the L-value adjustment antenna coil.

FIG. 8 depicts a structural example of a serial resonance circuit using the coil depicted in FIG. 6. Serially connected are a first coil (31) coiled about a hollow core in a generally square-shaped loop, a second coil (32) depicted in FIG. 6, and a capacitor (2). Such a serial resonance circuit is housed in a case (33) depicted in FIG. 9 and covered with a lid (34) depicted in FIG. 10.

The case (33) is formed in the shape of a generally square loop and is provided with a groove (35) to house the aforementioned first coil (31) and, on one side of groove (35), with a rectangular parallelepiped chamber (36). Drawn out from the chamber (36) to the outside are, respectively, a lead wire extending from one end of capacitor (2) and a lead wire extending from the first coil and connected to the transmission circuit (8). In a serial resonance circuit so structured, the second coil (32) is the antenna coil that FIG. 6 depicts and the thread volume of the screw (12) is appropriately adjusted to the desired property.

FIG. 11 and FIG. 12 depict structural examples of a serial resonance circuit relating to a different structure used in a transmission antenna. Coil (52) is coiled onto the first bobbin (51). In the center (hollow part) of the first bobbin, the second bobbin (54) on which coil (53) is mounted by winding is provided integrally to the first bobbin (51). In the center of the second bobbin (54) is provided a screw (55), which is a mobile ferrite core. The coil structure comprising this second bobbin (54) and the screw (55) is basically equivalent to the antenna coil structure that FIG. 6 depicts.

Provided in the supporting brim (56) on one side of the first bobbin (51) are terminals (57), (58), and (59). Between terminal (57) and (58) are connected a capacitor (2) while one end of the coil (52) is connected to terminal (59). A serial resonance circuit is formed by connections whereby the coil of the first bobbin (51) and coil (52) correspond to coil (L1) in FIG. 7, while the coil of the second bobbin (54) and coil (53) correspond to coil (L2) in FIG. 7. Terminal (57) and terminal (59) are connected to transmission circuit (8) to form a transmission antenna. In this transmission antenna too, the resonance frequency of the serial resonance circuit is set to the desired value by appropriately adjusting the thread volume of the screw (55).

### USABILITY IN INDUSTRY

In the present invention as described above, to a core whereon a coil is mounted by winding is magnetically joined a small core smaller in size than the former and the distance between the aforementioned core and the aforementioned small core is adjusted. Possibly, a screw made of ferrite, etc. whose inductance value is adjustable is provided and the screw volume of this screw is adjusted. The resonance frequency of the serial resonance circuit is set as desired by this adjustment, the inductance of the resonance frequency in the transmission antenna decreases, the current value in the resonance circuit increases, the magnetic flux radiated from the transmission antenna increases and, with the same power consumption, the communication distance can be extended, which is extremely beneficial.

1. Antenna coil characterized as provided with a core wherein a coil is mounted by winding and a small hole is perforated, and in the aforementioned small hole is provided a small core in a mobile fashion.

2. Antenna coil found in claim 1, characterized in that the aforementioned small core comprises a ferrite screw and the aforementioned small hole comprises a screw hole.

3. Antenna coil characterized as being provided with a core whereon a coil is mounted by winding; a small core smaller than this core; and a joining material that magnetically joins the aforementioned small core to the aforementioned core and that has a non-magnetic distance adjuster to adjust the distance between the aforementioned core and the aforementioned small core.

4. Antenna coil found in claim 3, characterized in that the aforementioned small core consists of a screw and in that a screw hole is formed in the aforementioned distance adjuster.

5. Antenna coil found in claim 3 or claim 4, characterized in that the aforementioned distance adjuster is mobile in the direction in which magnetic flux is generated from the aforementioned core comprising the aforementioned coil mounted by winding onto the aforementioned small core.

6. Antenna coil found in claim 3 whereby the aforementioned core and the aforementioned small core are both made of ferrite.

7. Antenna coil, characterized as outfitted with a first bobbin whereon a coil is mounted by winding; a second bobbin whereon a coil is mounted by winding and provided in the center of the aforementioned first bobbin; and a ferrite core provided in a mobile fashion in the center of the aforementioned second bobbin.

8. Antenna coil found in claim 7, characterized in that the aforementioned ferrite core comprises a screw and a screw hole is formed in the center of the aforementioned second bobbin.

9. Transmission antenna, characterized in that in a transmission antenna outfitted with an antenna coil having a core onto which a coil is mounted by winding and a capacitor connected to the aforementioned coil and forming a serial resonance circuit between the inductance of the aforementioned antenna coil, the aforementioned antenna coil is provided with a small core smaller in size than the aforementioned core and with a joining material that magnetically joins the aforementioned smaller core to the aforementioned core and with a non-magnetic material distance adjuster to adjust the distance between the aforementioned core and the aforementioned small core.

10. Transmission antenna found in claim 9, characterized in that the aforementioned distance adjuster is such that the aforementioned small core is mobile in the direction of the magnetic flux generated by the aforementioned core whereon the aforementioned coil is mounted by winding.

11. A transmission antenna provided with an antenna coil outfitted with a core whereon a coil is mounted by winding and a small hole is perforated, and a small core is provided in a mobile manner in the aforementioned small hole; and a capacitor connected to the aforementioned coil and forming a serial resonance circuit between the inductance of the aforementioned antenna coil.

12. Transmission antenna found in claim 11, characterized in that the aforementioned distance adjuster is such that the aforementioned small core is mobile in the direction of the magnetic flux generated by the aforementioned core.

13. Transmission antenna provided with an antenna coil outfitted with a first bobbin whereon a coil is mounted by winding; a second bobbin provided in the center of the aforementioned bobbin and whereon a coil is mounted by winding; and a ferrite core provided in a mobile manner in the center of the aforementioned second bobbin; and a capacitor whereby the coil wound onto the aforementioned first bobbin and the coil wound onto the aforementioned second bobbin are connected serially, and a serial resonance circuit is connected serially thereto between the inductance of the aforementioned antenna coil.

14. Transmission antenna characterized as provided with a first coil, a second coil wound onto a bobbin with a ferrite core provided in a mobile fashion in the center, and a capacitor, and in that the aforementioned first coil, the aforementioned second coil, and the aforementioned capacitor are serially connected to form a serial resonance circuit.
